(19) United States
(12) Patent Application Publication
(10) Pub. No.: US 2003/0069899 A1
(43) Pub. Date: Apr. 10, 2003

(54) Method, system, and program for providing personal preference information when scheduling events

(75) Inventors: Michael Wayne Brown, Georgetown, TX (US); Rabindranath Dutta, Austin, TX (US); Michael A. Paolini, Austin, TX (US)

Correspondence Address: David Victor, Esq, Ste. 501, 1180 South Beverly Dr., Los Angeles, CA, 90035, US

(73) Assignee: International Business Machines Corporation, Armonk, NY

(21) Appl. No.: 09/970,874

(22) Filed: Oct. 4, 2001

(51) Int. Cl. G06F 12/00

(52) U.S. Cl. 707/200

(57) ABSTRACT

Provided is a method, system, and program for providing information on scheduled events to attendees of the event. Electronic information on a scheduled event occurring at an event time and at an event location is transmitted. A response is received from an attendee indicating acceptance of the scheduled event. A scheduled event record is provided to include in a calendar database including calendar records, wherein calendar information for the attendee is generated from the calendar records for the attendee. A personal profile record is received for the attendee maintained in the calendar records in the calendar database including personal preference information of the attendee. Information on the attendee and the personal preference information is added to a record for the attendee in an attendee database. The attendee database is processed to access personal preference information on attendees.

### BACKGROUND OF THE INVENTION

1. Field of the Invention

The present invention relates to a method, system, and program for providing personal preference information when scheduling events.

2. Description of the Related Art

Portable computing devices, such as hand held computers, cellular phones, palm devices, etc., have become increasingly popular in recent years. The technology has advanced to such a degree that now people can access the Internet through wireless technology, such as a cellular phone or personal digital assistant (PDA), and review content especially tailored for a small portable device. The term PDA, as used herein, refers to any wireless, portable, and small hand held computer device, such as a palm computer, cellular phone, wearable computers, etc. Some of the most popular mobile applications for such wireless devices have included personal information managers (PIMs), entertinment programs, financial services, and mobile commerce.

One of the recent technological developments for mobile Internet access is the Wireless Application Protocol (WAP), which allows mobile devices to use data services and access the Internet. WAP provides a client/server architecture. A WAP enabled client, such as a cell phone or palm computer, can use micro browsers which are designed to operate within the small display screen of mobile devices and use less memory than a desktop browser. Content for mobile WAP enabled devices may be written in the Wireless Markup Language (WML), which provides a tagged mark-up language similar to the hypertext markup language (HTML), but designed specifically to function in a small-screen environment. Many content providers are providing WAP pages to enable access to the large base of mobile phone and PDA users.

Notwithstanding, recent developments in wireless computing, such as more advanced PIMs, Internet browsing and e-commerce features, only provide users with a significantly limited version of the programs and functions that are available at a desktop computer. For instance, a desktop PIM or calendar program provides a substantially more robust display presentation and range of program functionality than is available for mobile wireless device PIM applications. The same is true for Internet browsing. Given the substantial advantages of desktop PIM and Internet access programs over those available for mobile devices, most computer users, except the submarket of frequent business travelers, may not be motivated to purchase wireless devices for uses other than as a mobile telephone and limited PIM, e.g., address book, calendar, to do list, etc.

Thus, there is a need in the art for an application that would more fully exploit wireless computing technology to extend the utility beyond that of a portable telephone and limited PIM.

### SUMMARY OF THE PREFERRED EMBODIMENTS

Provided is a method, system, and program for providing information on scheduled events to attendees of the event. Electronic information on a scheduled event occurring at an event time and at an event location is transmitted. A response is received from an attendee indicating acceptance of the scheduled event. A scheduled event record is provided to include in a calendar database including calendar records, wherein calendar information for the attendee is generated from the calendar records for the attendee. A personal profile record is received for the attendee maintained in the calendar records in the calendar database including personal preference information of the attendee. Still further, the transmitted electronic information comprises an electronic message transmitted to an attendee device to display information on the scheduled event at the attendee device.

Further provided is a method, system, and program for accepting a scheduled event. Electronic information on a scheduled event occurring at an event time and at an event location is received. A response is transmitted indicating acceptance of the scheduled event. A scheduled event record is received to include in a calendar database including calendar records for the attendee, wherein calendar information for an attendee accepting the scheduled event is generated from the calendar records. A personal profile record for the attendee maintained in the calendar records for the attendee including personal preference information of the attendee is then transmitted.

Still further provided is a method, system, and program for tracking attendees of a scheduled event, wherein the scheduled event occurs during an event time period at an event location. Position records are provided in a database for the attendees, wherein each position record includes a time period value and position coordinates generated by a wireless device associated with the attendee that indicates a location of the wireless device for time periods. The position records for each attendee are processed to determine information to transmit to the attendee.

The described implementations provide methodologies for using calendar information for users maintained in a calendar database to access personal preference information on the users of a service or product to assist the event provider in supporting the personal preferences of the attendees. The described implementations further provide techniques for obtaining survey data based on the extent to which the user attended a particular event, where the survey may be tailored to the extent of the attendees participation in the event.

### BRIEF DESCRIPTION OF THE DRAWINGS

Referring now to the drawings in which like reference numbers represents corresponding parts throughout:

FIG. 1 illustrates a telecommunication environment in which aspects of the invention are implemented;

FIG. 2 illustrates components of a PIM database in accordance with implementations of the present invention;

FIGS. 3a, b, c, d illustrate data structures used in accordance with implementations of the present invention;

FIG. 4 illustrates further details of the telecommunication environment in which aspects of the invention are implemented;

FIGS. 5, 6, and 7 illustrate flowcharts of code logic to gather, process, and use location information in accordance with implementations of the present invention; and

FIGS. 8, 9a, and 9b illustrate examples of a display of user calendar and generated location information in accordance with implementations of the present invention.

FIG. 10 illustrates a data structure for a personal profile record in accordance with implementations of the invention;

FIG. 11 illustrates a computing environment for enabling an event provider server to interact with a personal information manager (PIM) server in accordance with implementations of the invention;

FIG. 12 illustrates a data structure for an attendee record maintained in an attendee database accessible to the event provider server in accordance with implementations of the invention;

FIG. 13 illustrates logic implemented in the PIM server and event provider server to provide personal preference information to the event provider server in accordance with implementations of the invention;

FIG. 14 illustrates an example of how information for shadowed scheduled event records may be displayed in a calendar view in accordance with implementations of the invention; and

FIGS. 15 and 16 illustrates logic to provide surveys to attendees of scheduled events in accordance with implementations of the invention.

### DETAILED DESCRIPTION OF THE PREFERRED EMBODIMENTS

In the following description, reference is made to the accompanying drawings which form a part hereof, and which illustrate several embodiments of the present invention. It is understood that other embodiments may be utilized and structural and operational changes may be made without departing from the scope of the present invention.

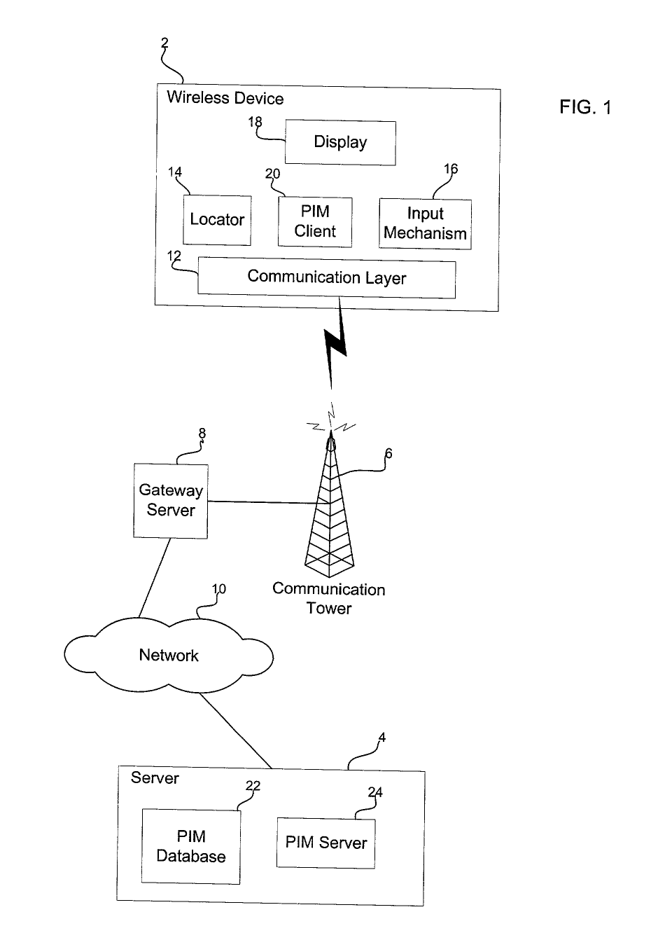

FIG. 1 illustrates a wireless computing environment in which embodiments of the invention are implemented. A wireless device 2, such as a telephony device, e.g., cellular phone, personal digital assistant (PDA), hand held computer, palm computer, etc., communicates with a server 4 via a communication tower 6, gateway server 8, and network 10. The server 4 may comprise one or more server class machines known in the art. The wireless device 2 includes a communication layer 12 which converts digital data into a signal that is transmitted to the communication tower 6 in a manner known in the art. The gateway server 8 converts the signals back into digital data to transmit via network 10 to the server 4. The network 10 may comprise any collection of devices, routers, etc. used to transmit data to a centralized server 4 providing data management for the wireless device 2 operations. The communication tower 6 and communication layer 12 may implement any known wireless transmission technology known in the art, such as 3G, Code-Division Multiple Access (CDMA), Global System for Mobile Communications (GSM), satellite, Bluetooth, etc.** **Bluetooth is a trademark of Telefonaktiebolaget LM Ericsson.

The wireless device 2 further includes locator technology 14 that provides a current position coordinate of the wireless device 2 in three dimensional space (x, y, z) on the surface of the earth and the time the position coordinate was generated. The locator 14 may comprise a global position satellite (GPS) receiver that is capable of calculating a current position based upon signals sent from satellites in a manner known in the art. Alternatively, the location of the wireless device 2 can be estimated externally from the wireless device by measuring the transmissions from the wireless device 2 using any known location positioning technology in a manner known in the art, such as Enhanced Observed Time Differential (E-OTD), Time Of Arrival (TOA), the CeRlPoint positioning system, the Ericsson Mobile Positioning System, etc.** In fact the United States Federal Communication Commission (FCC) mandated that cellular phone manufacturers incorporate technology to allow the location of the wireless device 2 to be determined. Any reference to the locator 14 refers to the locator technology used within the wireless device 2 that enables a position determination. For instance, if the locator 14 comprises a GPS receiver, then the locator 14 itself may determine the actual position coordinate. Alternatively, the locator 14 may provide information to an external component to enable the external component to determine the position coordinate of the wireless device 2. **Bluetooth is a trademark of Telefonaktiebolaget LM Ericsson.

The wireless device 2 further includes an input mechanism 16 for entering any type of data, including text, voice data, audio, images, movies, etc. The input mechanism 16 may include any known data input system known in the art, including a keyboard embedded in the device 2 with depressable keys, a touch sensitive displayed keyboard, a microphone for providing audio input, voice recognition software, still image camera, video recorder, pen-stylus text input system including handwriting recognition software, etc. Data entered by the user through the input mechanism 16 or downloaded from the server 4 can be rendered in display 18, which may comprise any electronic display device known in the art. A Personal Information Manager (PIM) client 20 gathers and presents PIM information, such as calendering and scheduling information, in accordance with the described implementations. The term “PIM” as used herein refers to a program designed to allow users to organize random bits of information in a useful format. The PIM program may enable calendar or scheduler operations. A calendar program enables one or more users to record and organize events and appointments. A scheduler program enables a group of colleagues to schedule meetings and other appointments, and share schedule and calendar information. Further, the PIM may be intended for use by a single individual for personal information or for use by a company or organization to provide information related to that persons involvement with the company or organization. The use of the term PIM or PIM program herein refers to any program that includes some or all of the above described calendar or scheduler functions, or any other functions those skilled in the art associate with PIMs.

The server 4 includes a PIM database 22 maintaining user PIM information and a PIM server 24 for gathering and filtering data from wireless devices 2 for the users of the system. The PIM database 22 may be implemented using any database technology known in the art, e.g., relational database, object oriented database, etc. Although FIG. 1 only shows one wireless devices 2, the server 4 and PIM database 22 may maintain data for multiple wireless devices 2 and users.

In the described implementations, the PIM client 20 gathers position coordinates for the PIM server 24. The PIM server 24 then uses the position coordinates to supplement the user calendar records with information on what the user actually did for time periods within a day. The user could then view this enhanced calender including listings of scheduled appointments as well as information describing the actual location and activities of the user and descriptions thereof The term “location” and “geographic location” as used herein refer to any location that may be mapped and ascertained. Such location or geographic location may be any location on the surface of the earth or the earth's atmosphere, or outer space, that can be expressed as a position coordinate in space. The term “location” or “geographic location” may refer to a specific position coordinate in space, e.g., an X, Y, Z coordinate, or a boundary or area of coordinates. Additionally, the location may be expressed as a vector. The term “position coordinate” as used herein refers to any of a set of numbers used in specifying the location of a point in space, or any one of a set of variables used in specifying the state or motion of an entity, such as a wireless unit or person, associated with the position coordinate.

The PIM server 24 includes the program logic that responds to data requests from PIM clients 20, accesses the PIM database 22 to perform database operations, and performs other data management operations related to managing the PIM database 22. The PIM server 24 may include a database management system (DBMS) known in the art or include an interface to access a DBMS program in a manner known in the art to perform operations with respect to the PIM database 22. The PIM server 24 may implement any database programming techniques for performing operations in the PIM database 22. For instance, the PIM server 24 may implement separate application programs for performing database operations or implement database stored procedures to perform database operations. The PIM client 20 includes those program components that gather coordinate and location information as described herein, communicates with the PIM server 24, and renders calendaring information at the wireless device 2.

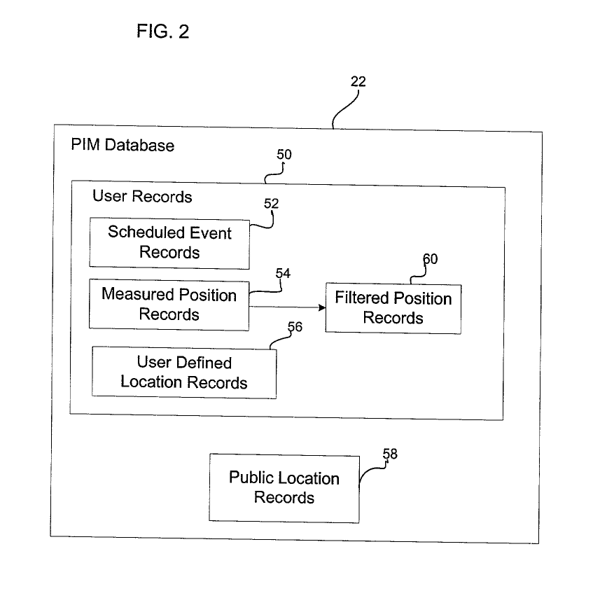

FIG. 2 illustrates the data components of the PIM database 22 maintained by the server 4. The PIM database 22 includes a plurality of user records 50 for each user of a wireless device 2 participating in the wireless computing environment described herein. Each user record 50 includes one or more user scheduled event records 52, measured position records 54, and location records 56 and 58. From the measured position records 54, the PIM server 24 generates filtered position records 60 that provide information on user geographic location and activity for time periods, such as information for a period of fifteen minutes, twenty minutes, one hour, etc.

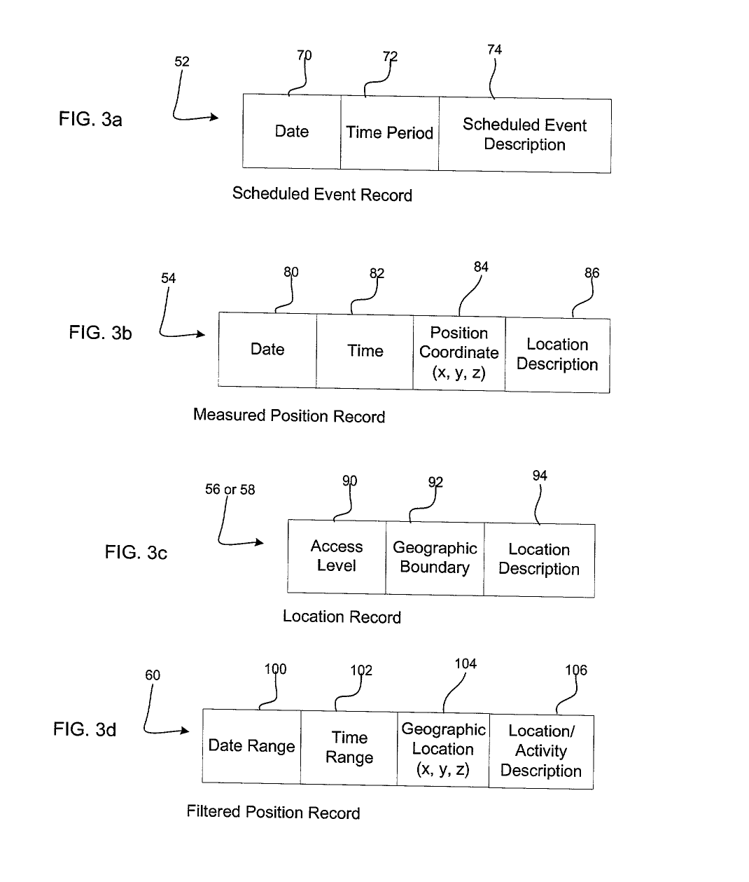

FIG. 3a illustrates fields in a user scheduled event record 52, including a date 70, time period 72 indicating a time range of the event, and a scheduled event description 74 providing information on the nature of the scheduled event. Through the client PIM 20 software, a user could use the input mechanism 16 to schedule a calendar event and create a scheduled event record 52. Additionally, the user could enter scheduled events from a desktop computer (not shown) that communicates with the server 4 via a network such as the Internet. The scheduled events may be shown in a calendar rendered on the display 18. Additionally, the scheduled events may be shown in a calendar rendered on another computer capable of accessing the server user records 50 in the server 4, such as a desktop computer communicating with the server 4 over the Internet.

FIG. 3b illustrates fields in a measured positioned record 54 for a user, including a date 80 and time 82 the position was measured, a position coordinate 84 expressed as a unique three dimensional x, y, z geographic coordinate on the surface of the earth, and a location description 86 providing descriptive information on the location. In the described implementations, the PIM client 20 periodically generates a measured position record 54 by obtaining the measured position coordinate (x, y, z) and the current time from the locator 14 (which may, in certain implementation interact with external components to provide the location and position coordinate). The location description 86 may be obtained locally at the wireless device 2 or determined subsequently by the server 4 as described in the following implementations.

FIG. 3c illustrates the fields maintained in the user defined 56 and public 58 location records. An access level field 90 indicates which users can be allowed to use the location record 56 or 58 to determine information about a location. The public location record 58 has public level access such that the PIM server 24 can consider a public location record 58 for any user in the PIM database 22. A user location record 56 can only be considered for the particular user that defined the location record 58 and any other authorized users in the system, as indicated by the access level 90. A geographic boundary field 92 defines a boundary of a defined region in three dimensional space. A location description field 94 provides a description of the location, which may include text, images, sound, movies, etc. A company maintaning the server 4, such as a telecommunication service provider, can use satellite maps and other information to determine the geographic boundaries in three dimensional space of various buildings and businesses. Business could register their geographic boundaries. Public location records 58 may then be generated for each of these determined geographic boundaries and include a description of the location within the geographic boundary.

The user specified location records 56 are generated by the user to provide information to include with the user's calendar. For instance, the user may obtain from a third party, such as a mapping company or organization, the geographic boundaries of an office or building and provide geographic boundary and location description information to the server 4 to include in a user location record 56. In another implementation, the user can activate a geographic boundary definition mode on the wireless device 2 to record position coordinates of a geographic boundary using the locator 14. In this geographic boundary definition mode, the user may walk or otherwise travel around a geographic area. While moving through the geographic area, the wireless device 2 would determine the x, y, z position coordinates at frequent intervals using the locator 14. The PIM client 20 or PIM server 24 can then use the determined position coordinates to determine a geographic boundary bounding all of the coordinates generated in the geographic boundary definition mode. This determined geographic boundary would then be included in the geographic boundary field 92 of the eventual user defined location record 56 stored in the user records 50 in the database 22. The user may further use the input mechanism 16 to enter information to include in the location description field 94 and the access level 90. The user access level 90 may specify that the user location record 68 be accessible to the user and other specified users, thereby limiting access of the location record 56 to a user defined group.

FIG. 3d illustrates a filtered position record 60 generated from a range of consecutive position records 54 having a same location description 86. The date range 100 and time range 102 for the generated filtered position record 60 would comprise the first and last dates 80 and times 82 of the consecutive position records 64 having the same location description 86. In this way, a single filtered position record 60 represents the data in multiple consecutive position records 54 having a same location description 106. Alternatively, a filtered position record 60 can consolidate multiple position records 54 that have position coordinates 84 within a predetermined proximity, without consideration of the location description 86. A geographic location field 104 indicates the common geographic location of the position records 60 having the same location description 86, which could include the geographic boundary from a location record 56 or 58 if the location description 86 of the consolidated position records 60 was determined from a location record 56 or 58.

Additionally, if algorithms in the PIM server 24 determine that a range of measured position records 54 define an activity, e.g., driving, walking, flying in an airplane, etc., then a filtered position record 60 would be generated for those position records 54 defining the activity. The date range 100 and time range 102 for the generated filtered position record 60 would comprise the first and last date 80 and time 82 of the consecutive position records 64 defining an activity and the location/activity description 106 field for this filtered position record 60 would include a description of the determined activity.

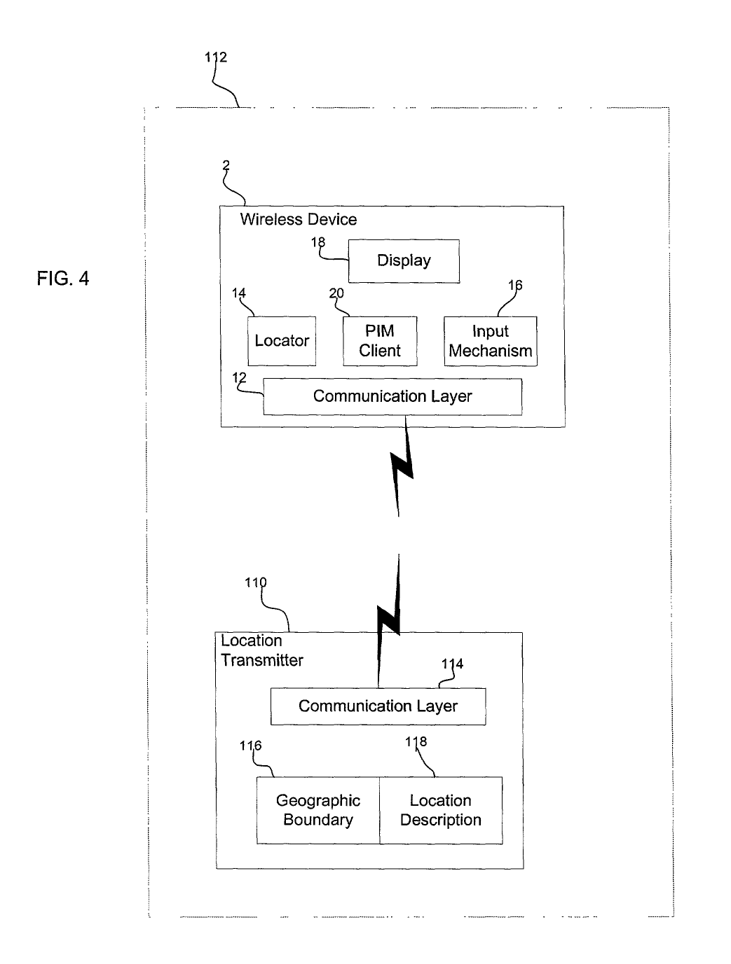

FIG. 4 illustrates an additional implementation of the telecommunication environment for obtaining geographic boundary information. A location tnnnitter 110 is maintained in a geographic location or boundary 112, such as an office, building, designated region, etc., and includes a communication layer 114 to transmit data throughout the geographic location 112. For larger geographic locations, multiple location transmitters 110 may be deployed to transmit throughout the entire geographic location 112. The location transmitter 110 maintains a geographical boundary 116, defining a region of x, y, z coordinates, and a location description 118 providing descriptive information on the geographic boundary 112. The local transmitter 110 is capable of transmitting the geographic boundary 116 and location description 118 through the communication layer 114 to any receiving device within the geographic boundary 102. For instance, the communication layers 12 and 114 of the wireless device 2 and location transmitter 110, respectively, may implement Bluetooth technology. In such Bluetooth implementations, the location transmitter 110 may continually transmit packets containing an Inquiry Access Code (IAC) to establish communication with any wireless devices 2 within the geographic boundary 112. The wireless device 2 may then respond to establish a connection with the local transmitter 110. Upon establishing the connection, the local transmitter 110 may then transmit the geographic boundary 116 and location description 118 through communication layer 114 to the communication layer 12 of the wireless device 2. Further details of Bluetooth communication technology are described in the publication “Bluetooth(TM): Connect Without Cables” by Jennifer Bray and Charles F. Sturman (Copyright 2001, Prentice Hall), which publication is incorporated herein by reference in its entirety. In alternative implementations, the communication layers 12 and 114 may utilize wireless communication protocols other than Bluetooth known in the art to perform the communication operations described herein, such as the wireless LAN architecture standard proposed in IEEE 802.11.

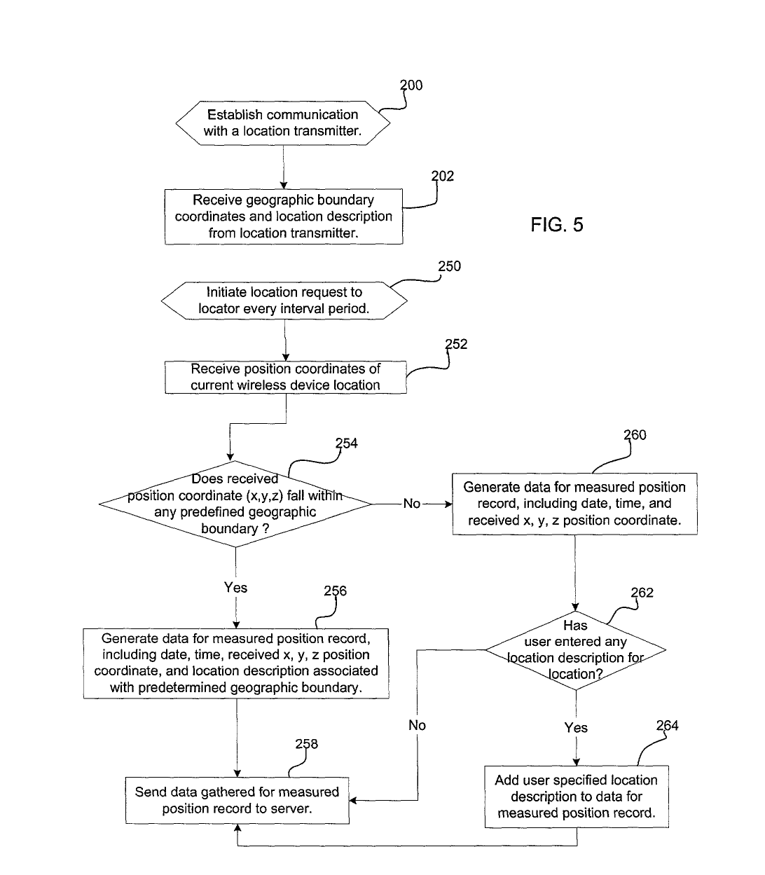

FIGS. 5-7 illustrate logic implemented in the PIM client 20 and server 24 to gather and utilize position information concerning the wireless device 2. FIG. 5 illustrates logic implemented in the PIM client 20 to gather position information to provide to the PIM server 24 to include within measured position records 54 in the database 22. At block 200, the wireless device 2 establishes communication with a location transmitter 110, using the Bluetooth technology or other wireless technology known in the art. After establishing a connection with the location transmitter 110, the PIM client receives (at block 202) a geographic boundary 116 comprised of X, Y, Z coordinates defining a three dimensional boundary on earth and location information describing the geographic boundary 116.

To provide data to the PIM server 24, the PIM client 20 performs steps 250 through 264 in interval time periods, e.g., every few seconds, minute, etc., to measure the current location and generate measured position records 54. At block 250, the PIM client 20 initiates a location request to the locator 14 or other unit to determine the current position coordinate (x, y, z) of the wireless device 2. Upon receiving (at block 252) the position coordinate from the locator 14, the PIM client 20 determines (at block 254) whether the received position coordinate falls within any predefined geographic boundaries supplied by a location transmitter 110, the PIM server 24, a user defined location record 56, or any other geographical boundary maintained by the PIM client 20. If so, the PIM client 20 generates (at block 256) data for a measured position record 54, including the received position coordinate, the date and time the coordinate was determined, and any location description associated with the predefined geographic boundary including the received position coordinate. The gathered data is then sent (at block 258) to the PIM server 24 to include as a position record 54 in the user records 50.

If (at block 254) the received position coordinate did not fall within any predefined geographic boundary, then the PIM client 20 generates (at block 260) data for a measured position record 54 including the received X, Y, Z position coordinate and the date and time the coordinate was measured. If (at block 262) the user has entered through the input mechanism 16 any location description for the current location through the input mechanism 16, then the PIM client 20 adds (at block 264) the user specified location description to the data for the measured position record. From block 264 or the no branch of block 262, the PIM client 20 transmits the data for the measured position record 54 to the PIM server 24 to include in the user records 50.

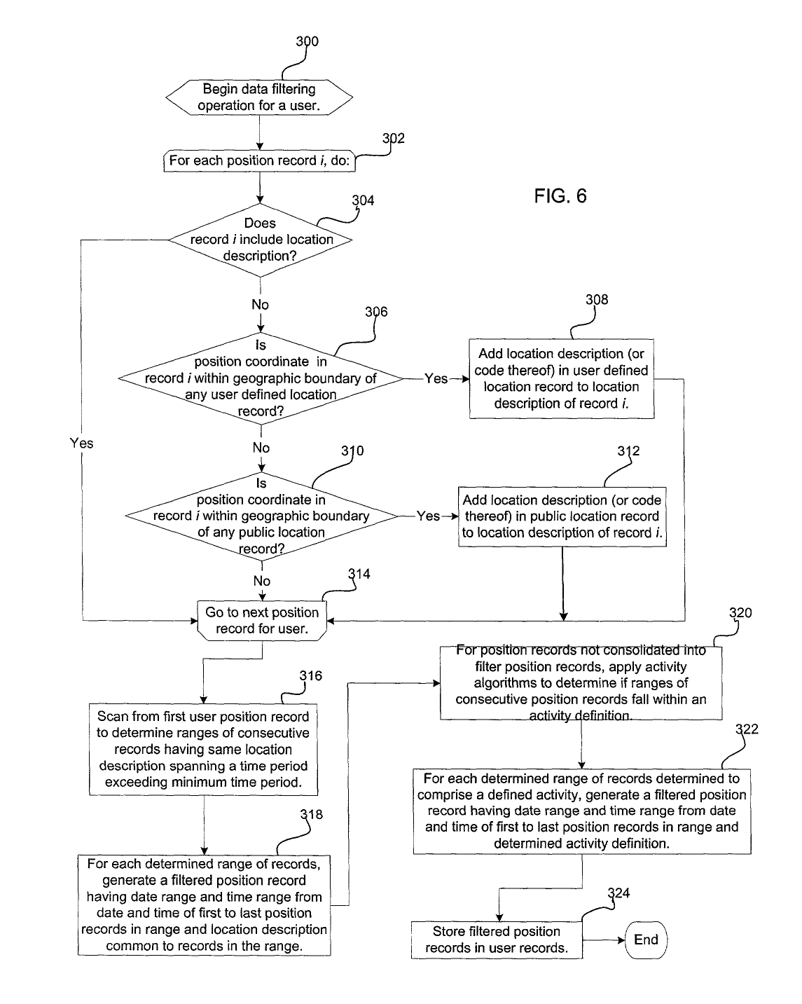

FIG. 5 provides logic implemented in the PIM client 20 to gather the position records for each measured coordinate. FIG. 6 illustrates logic for a filtering algorithm that consolidates and interprets the measured position records 54 and generates filtered position records 60 that provide information on the user's whereabouts and activities for time periods. The filtering algorithms used to generate the filtered position records 60 may be implemented in either the PIM client 20 or PIM server 24. In the event that the PIM client 20 (FIG. 1) executes the filtering algorithm, then the PIM client 20 would transmit the filtered position records 60 to the PIM server 24 to store in the PIM database 22.

With respect to FIG. 6, control begins at block 300 with the invocation of the filtering algorithm for the user records 50 of a particular user. A loop is performed from blocks 302 to 314 for each measured position record i in the user records 50 that has not yet been subject to filtering to add location description information 86 to the measured position record 64 if such data was not provided by the PIM client 20. If (at block 304) the measured position record i does not include any location description 86 data, then a determination is made (at block 306) as to whether the position coordinate 84 data in record i is within the geographic boundary of any user defined location records 56 of the user being considered. If so, then the location description 94 for the user defined location record 90 is added (at block 308) to the location description 86 data for the measured position record 64. If (at block 306) a geographic boundary was not located in the user defined location records 56, then a determination is made (at block 310) whether the position coordinate 84 data in record i is within the geographic boundary of any public location records 58. If so, then the location description 94 for the public location record 58 is added (at block 312) to the location description 86 data for the measured position record 64. From the yes branch of block 304 (if there is already location information added by the PIM client 20) or from blocks 308 or 312, control proceeds to block 314 to consider all the measured position records 54 for the user. The related application entitled “Method, System, and Program for Providing User Location Information for a Personal Information Management System”, having attorney docket no. AUS920010221US1, which is incorporated by reference in its entirety above, provides additional implementations for obtaining location description information from the user records for other entities and persons in the PIM database 22.

After the measured position records 64 are supplemented with location information from user defined 56 or public 58 location records, then control proceeds to blocks 316 to generate the filtered position records 60 that are particularly suited for use in a PIM or calendaring program. At block 316, the filter scans from the first user position record 54 to determine ranges of consecutive position records 54 having the same location description 86 spanning a time period exceeding a minimum time period. Thus, the filter is looking for position records indicating that the user was at a same location for a minimum time. The minimum time may be a time period of sufficient length that would be meaningful to display in a PIM interface, such as a calendar or schedule, e.g., 10 minutes, etc. For each determined range of records, a filtered position record 60 is generated (at block 318) having a date 100 and time 102 ranges from the date and time of the first to last position records in the determined range and having a location description 106 that is the common location description 86 found in the position records 54 in the determined range. In this way, a single filter position record 50 is generated that defines a location position that was maintained for a minimum time.

At block 320, activity algorithms may then be applied to those position records not consolidated into filtered position records 58 at block 316 and 318. An activity algorithm would analyze a series of consecutive measured position records and based on a rate of change in distance per unit of time, determine a predefined activity associated with the position records. For instance, a range of consecutive measured position records 54 whose position coordinate 84 (x, y, z) is rapidly changing may indicate that the user is traveling in an automobile or other transportation vehicle. Other rate of changes may indicate other activities, e.g., walking, running, bicycle riding, etc. For each determined range of measured position records 54 that define an activity, a filtered position record 60 is generated (at block 322) having a date 100 and time 102 ranges from the date 80 and time 82 of the first and last measured position records 54 in the range and an activity description field 106 set to the activity determined for the range. The geographic location field 104 may comprise a range of first and last locations for the activity, wherein the first location would comprise the location 84 data from the first measured position record 64 in the range for the activity and the last location would comprise the location data 84 from the last record 84 in the range. Thus, in certain described implementations, a filtered position record 60 indicates a time period during which a user was at a location, defined by a geographic boundary or a time period during which the user was engaged in an activity involving movement from one location to another.

The filtered position records 60 are then stored (at block 324) in the PIM database 22 for later use. The filtered position records 60 provide more usefull descriptive information than the measured position records 54 because they indicate time periods spent at meaningful geographic locations or engagement in a particular activity.

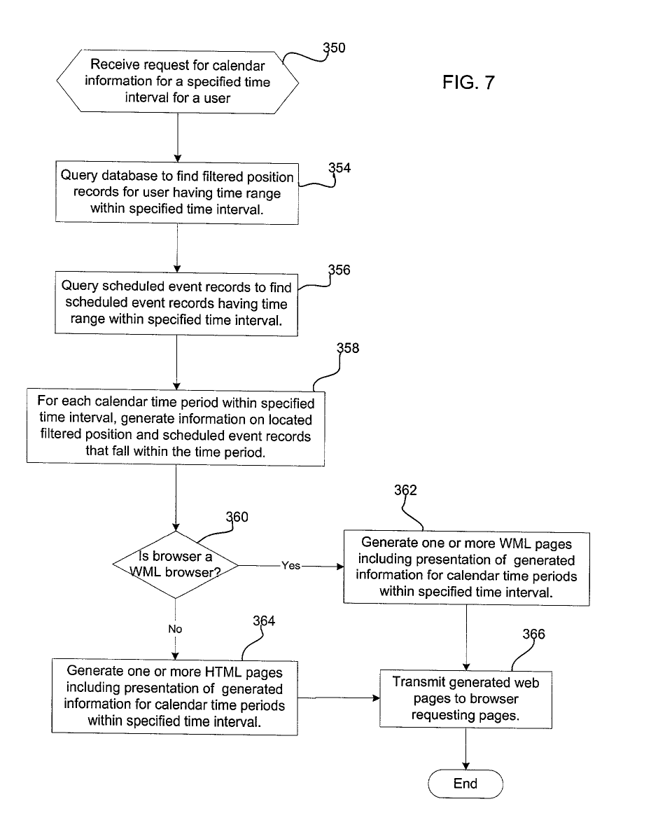

FIG. 7 illustrates logic implemented in the PIM server 24 to generate calendar information that can be displayed at the wireless device 2 or some other computer in communication with the server 4, such as a desktop computer accessing the server 4 over the Internet. Control begins at block 350 with a request for PIM information for a time interval for a user. In response, the PIM server 24 queries the PIM database 22 for filtered position records 60 (at block 354) and scheduled event records 52 (at block 356) of the user within the specified time interval. The PIM server 24 then generates (at block 358) for each calendar time period, e.g., every half-hour, hour, etc., information on the scheduled event description 74 and the location/activity description 106 (FIGS. 3a, d) in the located scheduled event 52 and filtered position 58 records, respectively, that fall within the calendar time periods that span the specified time interval.

If (at block 360) the viewer program requesting the calendar information for the time period is a WML browser on a small device, e.g., the wireless device 2, then the PIM server 24 generates (at block 362) one or more WML pages including a presentation of the information generated for each calendar time period in the user specified time interval including information on user scheduled events and actual location/activity. Otherwise, if the viewer or browser requesting the calendar information includes a larger display area, then the PIM server 24 generates (at block 364) one or more HTML pages including the presentation of the generated calendar information. From blocks 362 or 364, control transfers to block 366 to transmit the generated web pages to the browser requesting that page. Alternatively, the PIM server 24 may include the generated calendar information in an Extensible Markup Language (XML) or other file that is sent to the PIM client 20 to render on the local display. Thus, the calendar information presented to the user may include a description of user scheduled events as well as information on the geographical locations the user associated with the wireless device 2 visited during the specified time interval.

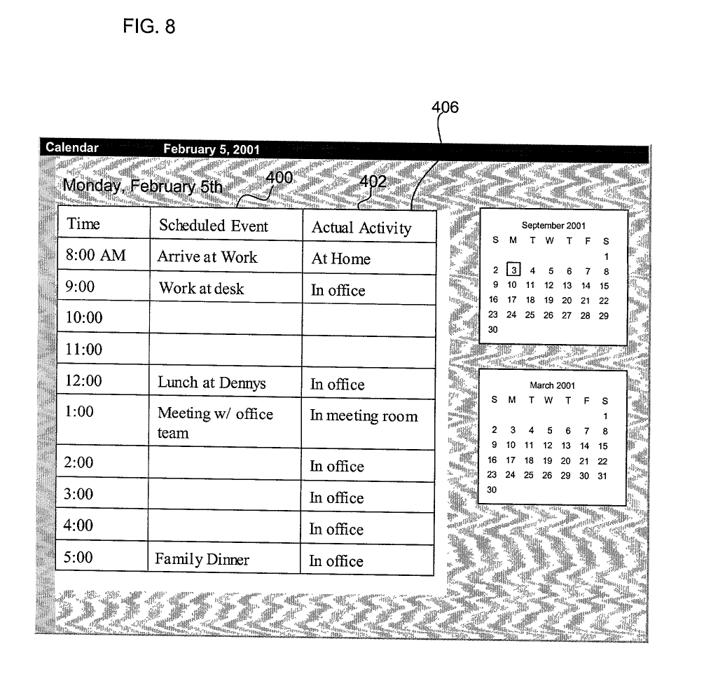

FIG. 8 illustrates an example of calendar information for the user specified time period presented in a calendar window 400 rendered on a computer display monitor. As shown, the calendar displays both user scheduled events 402 from the scheduled event records and actual location/activity 404 from the filtered position records for calendar times 406 during the specified time interval. In this way, the user may compare what was scheduled with what actually materialized. Moreover, in implementations where the PIM server 24 updates the user calender information in real time and generates real time filtered position records, the calendar 400 could display the user's current geographical location. This information could be useful for business associates and others interested in the user's location. Additionally, the actual location/activity 402 may be displayed in an abbreviated format. The user may use an input device to selectively display further details on the actual location/activity. For instance, the user may move a mouse input device over the displayed abbreviation of the actual location/activity or click the displayed abbreviation to cause the display of more detailed information on the actual location/activity in the calendar window 400.

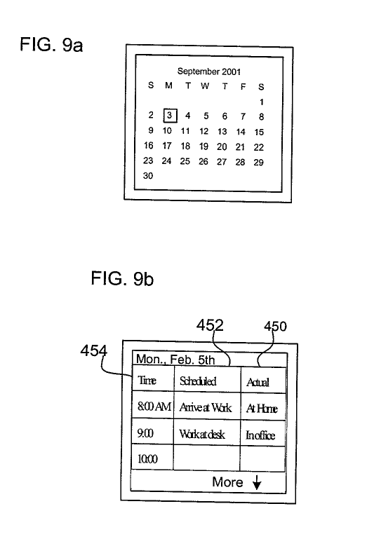

FIGS. 9a, b illustrate how calendar information may be displayed on a display 18 of a wireless device 2 having limited display space. FIG. 9a illustrates a small displayed monthly calendar. Upon user selection through the input mechanism 18 of a particular day, e.g., February 5^{th}, the PIM client 20 displays the view shown in FIG. 9b which provides information of scheduled events 450 and actual user location/activity 452 for a portion of the calendar times 454 during the user requested time interval. The user can use the input mechanism 18 to scroll downward to view further calendar entries.

The described implementations provide a technique for gathering and utilizing user position information for use with a PIM or calendaring program. This position information may be provided to the user and those authorized by the user to track actual activity versus scheduled activity.

### Providing Information on User Preferences

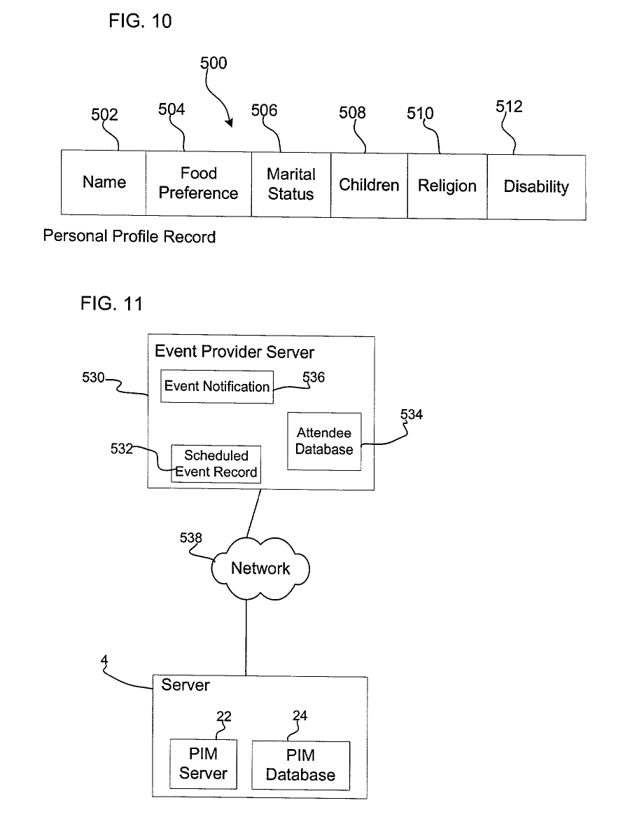

In additional implementations, the user records 50 in the PIM database 22 may include personal preference information to provide to commercial or noncommercial third parties. FIG. 10 illustrates an example of a personal profile record 500 maintained in the user records 50 for users of the PIM database 50, including:

Name 502: provides the user's name

Food Preference 504: indicates any dietary preferences for the user, such as vegetarian, macrobiotic, kosher, milk free, etc.

Marital Status 506: indicates whether the user is married

Children 508: indicates a number of children the user has.

Religion 510: indicates the user's religion.

Disability 512: indicates whether the user has any disabilities, e.g., hearing impaired, handicapped, wheelchair bound, etc.

In certain implementations, third parties may organize scheduled events to which users of the PIM database 22 may elect to attend. For instance, a user of the PIM database 22 may receive an e-mail concerning a scheduled event, such as a company picnic, an entertinment event, concert, family gathering, dinner party, etc. FIG. 11 illustrates a computing environment where an event provider server 530, used by the entity sponsoring the event, is in communication with the server 4 and PIM server 24 described with respect to FIG. 1 to provide information on events to users of the PIM database 22. The event provider server 530 comprises the computer system the provider of the event, e.g., company, commercial entity, friend, etc., utilizes to enable users of the PIM database 22 to reserve attendance to the event. The event provider server 530 includes a scheduled event record 532 to add to the user records 50. When generating a calendar view (FIG. 8), information from the scheduled event record 532 would be displayed as a scheduled event. The event provider server 530 further -maintains an attendee database 534 that maintains records on attendees that have indicated acceptance to attend the scheduled event. The event provider server 530 fierier includes an event notification 536, which may comprise an e-mail, HTML web page, or other electronic document to transmit to the user's wireless device 2 or other system. The event provider server 530 and PIM server 4 communicate over a network 538, such as the Internet, an Intranet, or any other network system.

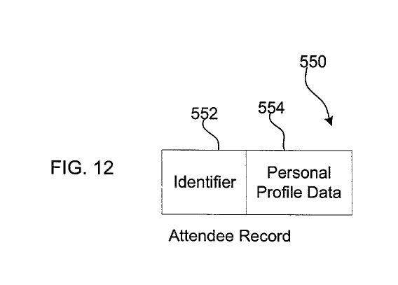

FIG. 12 illustrates an example of an attendee record 550 in the attendee database 534, including an identifier 552 of the attendee and personal profile data 554, which would comprise data from the personal profile record 500 transmitted from the PIM database 22.

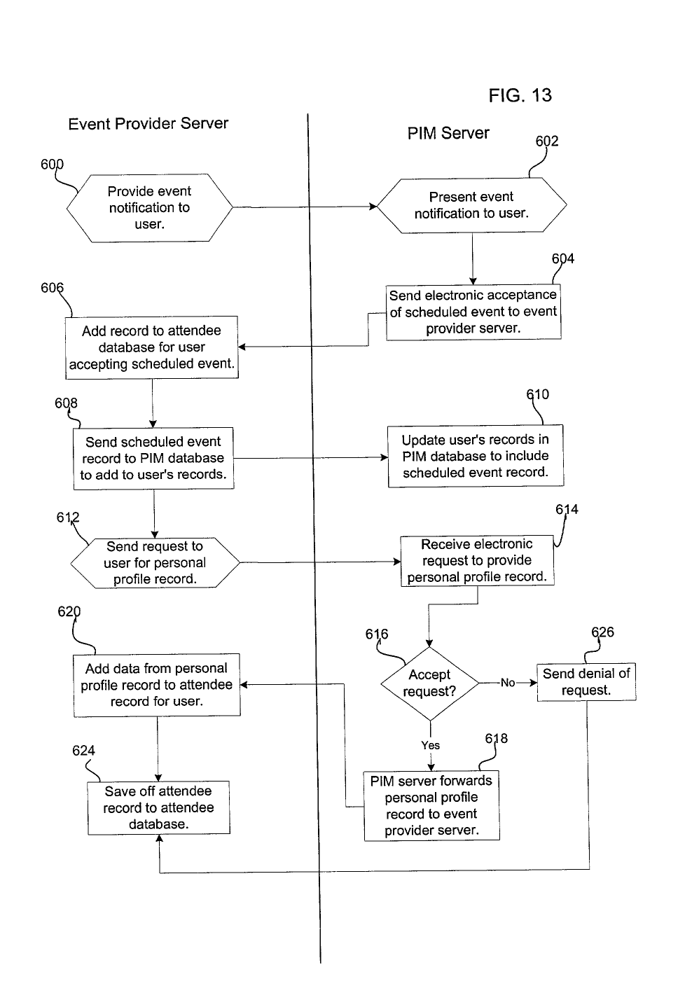

FIG. 13 illustrates computer implemented operations performed in the event provider server 530 and PIM server 24 to provide the personal profile record 500 in the PIM database 22 to the event provider server 530. Control begins at block 600 with the event provider server 530 providing an event notification 536 to a user of the PIM database 22. The event notification 536 may comprise an e-mail describing the event that is displayed (at block 602) on the user's wireless device 2 or other system. Alternatively, the event notification 536 may comprise a web page the user downloads and views using a web browser on the wireless device 2 or other system.

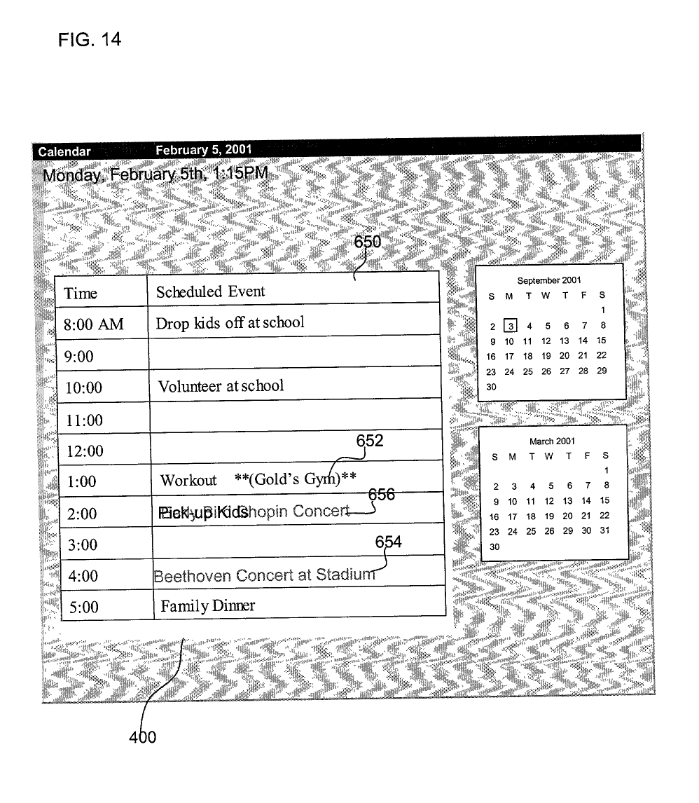

In still further implementations, the event notification 536 may comprise a shadowed event that is added to the user's database records 52 to display as a shadowed event, i.e., an event that is displayed in the user's calendar as a non-committed event, not a scheduled event. Shadowed events are displayed “optional events” that the user may selectively add to the regular scheduled event records 52 (FIG. 3a) that are displayed as regular scheduled events. In this way, the shadowed events are not “hardened” scheduled events until the user selects to add the shadowed event to the user schedule by converting the shadowed event to a scheduled event record 52 in the user records 50. For instance, in certain implementations, the shadowed event does not override or conflict with a regular user scheduled event record 52. For instance if a user schedules two user events at the same time, for which separate scheduled event records 52 would be created, then a conflict signal may be generated notifying the user of the conflicting scheduled events. However, for shadowed events, if the shadowed event is scheduled at the same time as a regular user scheduled event, then the shadowed event may be displayed as a transparency over the regular scheduled event. In such case, no conflict signal would be generated indicating an attempt to schedule conflicting appointments because the shadowed event is an event from another entity the user is monitoring and is not considered an event the user is adding to their own schedule. The user may select to accept or “harden” the shadowed event, which would transform the shadowed event into a user scheduled event record 52. User selection to harden the shadowed event into a regularly scheduled event may override any previous scheduled event for that time slot. Further details on presenting shadowed scheduled events in a user's calendar using the PIM database 22 are described in the copending and commonly assigned patent application entitled “Method, System, and Program for Accessing Calendar Information for Shadowed Users from a Database”, having attorney docket no. AUS920000714US1, which patent application is incorporated herein by reference in its entirety. FIG. 14 provides an example of displayed shadowed events 654 and 656, which are displayed in a different manner than the actual scheduled events 652.

The event notification 536 may include a hypertext link or some other programming mechanism to enable the user to send an acceptance of the scheduled event through the event notification 536. Alternatively, if the notification comprises the display of a shadowed scheduled event 654 and 656 as shown in FIG. 14, then the displayed name of the shadowed event may comprise a hypertext link to enable the user to accept the scheduled event and return notification of acceptance of the event to the event provider system 530.

Upon the user sending (at block 604) electronic acceptance of the scheduled event to the event provider server 530 through the PIM server 24, which may be performed in response to selection of the hypertext link in the event notification 536, the event provider server 530 adds (at block 606) an attendee record to the attendee database 534 for the user accepting the scheduled event. The scheduled event record 532 is then sent (at block 608) to the PIM database 24 to add to the records of the user that accepted the scheduled event. In response, the PIM server 22 updates (at block 610) the user's records in the PIM database 24 to include the scheduled event record 532, such that when the user alter reviews a calendar generated from the user scheduled event records, the accepted event would be displayed. The event provider server 530 then sends (at block 612) a request to the user for the personal profile record 500. Upon receiving such request (at block 614), if (at block 616) the user accepts the request, by selecting a hypertext link or an accept button that transmits acceptance, then the PIM server 24 would forward the user's personal profile record 530 in the user records 50 to the event provider server 530. The event provider server 530 would then add (at block 620) the data from the transmitted personal profile record 500 to the personal profile data 554 in the attendee record 550 in the attendee database 534, and then save the added record (at block 624). If the user selected the option to not accept the request, then the event provider server 530 would save the attendee record 550 without personal profile data 554.

The event provider may then use the user personal preference information stored in the attendee database 534 when planning for the event. For instance, if the event is a corporate picnic, then the company may review the food preference 502 (FIG. 10) data for accepting users and use such information to provide a menu that accommodates employee food preferences, e.g., vegetarians, etc. The event provider may use the marital status to estimate the number of children that may attend to determine the extent child entertainment is needed. The disability information 510 may be used to determine the extent to which disability accommodations must be provided, such as a sign language interpreter if the attendees include hearing impaired individuals, wheelchair access, etc.

As discussed, the event provider may comprise any person planning an event, including companies planning events for employees, individuals planning a party, businesses planning a meeting or conference, etc. In such case where the event provider is a large entity, then the event provider server 530 may comprise one system used by the event provider. Additionally, if the event provider is an individual interested in planning a personal dinner party or other gathering, then the event provider server 530 may comprise a third party Application Service Provider (ASP) that performs the event provider server steps in FIG. 13 on behalf of the event provider. An ASP can also be used by large entity event providers.

In further implementations, the event provider may comprise a commercial entity selling services that are rendered at a specific time. For instance, if the event provider comprises an airline carrier, then the scheduled event record 532 (FIG. 11) may comprise the purchased reservation. The airline carrier could use the personal information to better serve the user, such as providing meals tailored to their food preference, marketing directed to their marital and child status, etc.

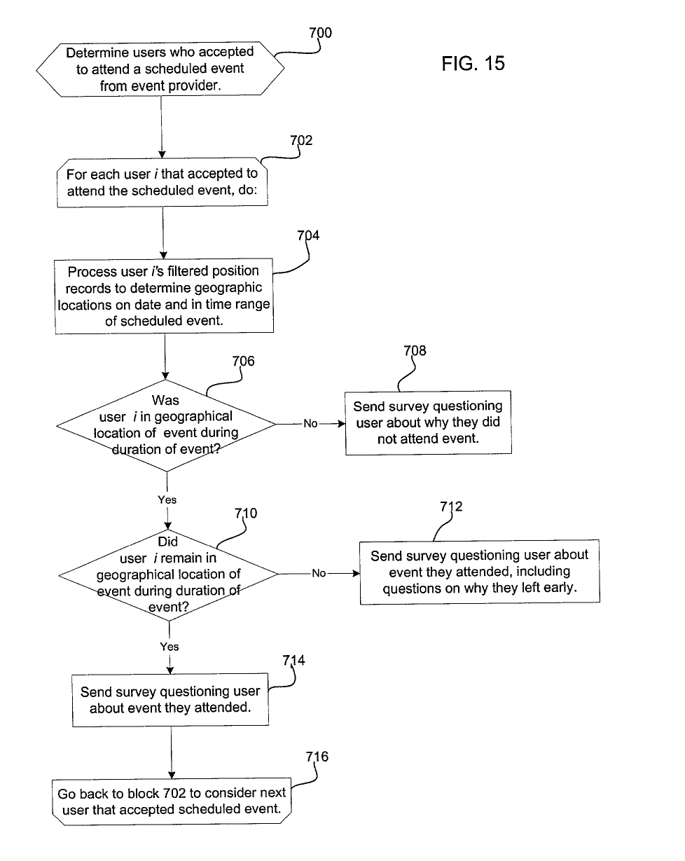

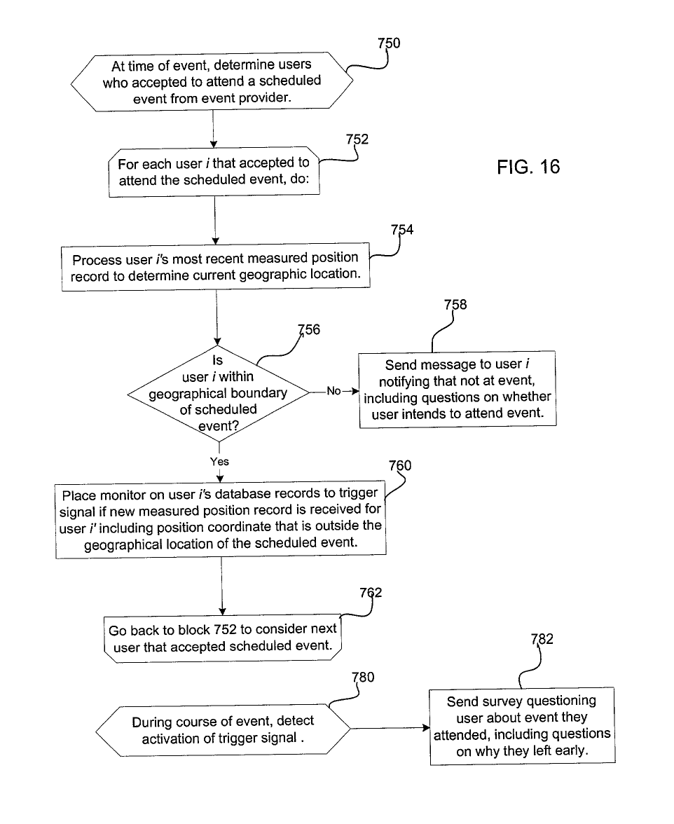

In the above described implementations, users provided personal information data to an event provider server 530 through a personal profile record 500 maintained for the user in the PIM database 22. In alternative implementations, the event provider may perform data mining on the filtered position records 60 (FIG. 3d) to determine user preferences for the scheduled event. Such data mining operations may be performed through the PIM server 24 or some other system having access to the user records 50 in the PIM database 22. FIGS. 15 and 16 illustrate logic implemented in the PIM server 24 or some other system performing data mining on the PIM database 22. The logic may be performed within the PIM server 24 on behalf of the event provider system 530 to monitor the PIM database 22 and provide resulting survey information to the event provider server 530 or event provider. Alternatively, the logic of FIGS. 15 and 16 may be performed by the event provider server 530 by monitoring the PIM database 22 in a client/server database architecture known in the art.

FIG. 15 provides logic to perform data mining after the scheduled event has completed. Control begins at block 700 with a query of the PIM database 22 to determine users whose records 50 indicate that they accepted to attend a scheduled event from the event provider. Such determination at block 700 can be made by determining those users whose scheduled event records 52 include the event provider's scheduled event as an accepted record. Alternatively, the determination of users that accepted can be made from the event provider server 530's attendee database 534 for the scheduled event being analyzed. After determining all users that have accepted the event, a loop from blocks 702 through 716 is performed for each determined user i. At block 704, user i's filtered position records 60 (FIG. 3d) are processed to determine the geographical locations 104 of the user within the date and time range of the scheduled event. A determination is made (at block 706) of whether user i's filtered position records 60 (FIG. 3d) indicate that user i's wireless device 2, acting as a proxy for user i's position, was located in the geographical boundary of the scheduled event, e.g., the geographical boundary in (x, y, z) coordinates of the venue of the scheduled event, e.g., theater, park, building, home, etc. If the user/attendee was not positioned within the geographical position or boundary of the event within the time and date range of the event, then a survey, e.g., e-mail message or other electronic notification, is sent (at block 708) including questions requesting information from the user on why they did not attend the event. The electronic survey may include check boxes and other fields that would enable the user to provide a response to the survey questions.

If (at block 706) the user was in the geographical boundary of the scheduled event within the date and time range of the event, then a determination is made (at block 710) of whether user i remained within the geographical boundary of the event during the duration of the event or for some minimum amount of time. If the wireless device 2 did not remain in the geographical boundary of the event for the event duration or for the minimum amount of time, then an electronic survey is sent to (at block 712) the wireless device 2 or other system of user i including questions inquiring why user i left the event early. Otherwise, if the wireless device 2 for user i remained in the event boundary for the event duration, then an electronic survey is sent (at block 714) to the wireless device 2 of user i inquiring about their opinion as to the event they intended.

With the described logic of FIG. 15, an event provider can send targeted surveys to those users that attended the event including question specifically tailored to the extent of the attendees absence, partial attendance or fall attendance at the event. In certain implementations, the input mechanism 16 (FIG. 1) of the wireless device 2 can be used to enter responses to the questions in the electronic survey that can be transmitted back to the PIM server 4 or other system performing the query. The logic of FIG. 15 allows the event provider to gather information on user attitudes about the scheduled event after the event has completed. The user's response to the survey may be transmitted as a retumed e-mail message, or using any file transfer protocol known in the art, e.g., HTTP, FTP, etc.

FIG. 16 illustrates logic to perform real-time data mining of an event during the pendency of the event. At the beginning of the event, control begins at block 750 with a query of the PIM database 22 to determine users whose records 50 indicate that they accepted to attend the scheduled event sponsored by the event provider. Alternatively, the determination of users that accepted can be made from the event provider server 530's attendee database 534 for the scheduled event being analyzed. After determining all users that have accepted the event, a loop from blocks 754 through 760 is performed for each determined user i. At block 754, user i's most recently gathered measured position record 54 (FIG. 3b), which, as discussed above, comprises the real-time data from the wireless device 2, is accessed to determine the current geographical location of user i from the position coordinate 84 within the accessed measured position record 54. In the described implementations, a digital representation of a geographical boundary of the venue for the scheduled event is maintained. In certain implementations, the PIM server 22 may immediately transmit a new measured position record 54 to the event provider server 530. Alternatively, the PIM server 22 may perform all the PIM database 24 data mining operations described with respect to FIGS. 15 and 16.

If (at block 756) user i is not located within the geographical boundary of the scheduled event, then a message is sent (at block 750) to the wireless device 2 or other system of user i notifying user i that they are not at the event. The message may include questions to user i inquiring about their absence from the scheduled event. If the user i is located within the geographical boundary, then a monitor, such as a database trigger, is set (at block 760) on user i's database records to trigger a signal if a new measured position record 54 is received including a position coordinate 84 value that is outside the venue of the scheduled event.

At block 780, if during the time frame of the scheduled event, a trigger signal for one user is detected, then an electronic survey is sent (at block 782) to the user questioning the user about the event they attended and left, including inquiries on why they left early. This electronic survey may be transmitted immediately to the wireless device 2 of the user to obtain immediate, real-time, feedback about the user's reasons for leaving the venue of the event. Additionally, a survey may be sent later to all users that remained at the event for the entire period, or immediately after the event completes.

In still further implementations, an analysis may be performed on what was occurring at the scheduled event when the user had left the venue of the event, i.e., at the time in the measured position record 54 that includes the position coordinate 84 value outside of the event venue. This would be especially useful for the movie industry when screening a movie to correlate people leaving a movie during a particular scene. For instance, the movie may be previewed to people and wireless devices 2 provide to allow the gathering of real-time survey data to improve the accuracy of information gathered about the attendees' reaction to the screened movie.

The described implementations provide user personal information to an event provider before the event begins to allow the event provider to tailor what is offered at the event e.g., the food or services offered, based on the personal preferences of the user provided through the user's calendar PIM database 22. Further, during or after the scheduled event, the user's calendar information in the PIM database 22 can be used to submit tailored surveys to the user based on their attendance (through the wireless device 2) at the venue including the event in the hope of receiving immediate feedback based on the user's perception of the event.

Additionally, the above described implementations may be used to transmit and gather additional types of information with respect to users having wireless devices within the geographical boundary of a scheduled event. The event provider may provide real-time information to a user within the geographical boundary of the event. For instance, during a sporting event, the event provider may transmit player and game statistics, streaming media of the event or replays, commentary, or allow the user to “make the call”, i.e., voice an opinion on whether the referee made the correct call; call. During an airline flight, the event provider may transmit information on the current position, weather, estimated time of arrival, picture of the cockpit or etc. Further, the event provider may allow the user's within the geographical boundary to transmit real-time information, such as complaints about the room temperature, technical difficulties at event, etc.

### Additional Implementation Details

The described aspects of the invention, including the logic described with respect to the PIM client and server and any other devices, may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and nonvolatile memory devices (e.g., EEPROMs, ROMs, PROMs, RAMs, DRAMs, SRAMs, firmware, programmable logic, etc.). Code in the computer readable medium is accessed and executed by a processor. The code in which the invention is implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

The scheduled event sponsored by the event provider may comprise any event within a geographical boundary and within a specific time range, such as an entertainment event, gathering, party, product sale, promotional event, conference, convention, etc.

The electronic surveys presented to the user's in the logic of FIGS. 15 and 16 may be sent to the user's wireless device 2 or any other system whose address the user has made available.

In the described implementations, the wireless device obtains the position coordinates and time and date information and transmits the data to the server 4. In alternative implementations, telecommunication devices or towers can detect the location of the wireless device and transmit the data for the measured position record 54 directly to the server 4. In such implementations, the wireless device would not be involved in transmitting position coordinates for the measured position records.

In the described implementations, the event provider server 530 was described as located external to the PIM server 4. In alternative implementations, the event provider server 530 may be implemented within the server 4 as a supplemental service performed by the PIM server 22.

The described implementations concerned maintaining user location information with a user calendar program. The described implementations can further be used to provide and utilize a persons geographic location and/or activities for a measured time period for any purpose, not just calendering. For instance, a company may want to track the location and activity of workers. The company can then filter and compare a workers actual location/activity with their work schedule. Such information would be particularly useful for manufacturers and others attempting to determine optimal human resource allocation in the workplace.

The PIM location/activity information of the described implementations would also be very useful for companies that have to send workers out to field locations, such as cable companies, telephone companies, plumbers, etc., to track how the worker's actual location/activities correspond to those scheduled. In the case that real time worker location/activity information is provided to the calendar display, then the company can track the workers schedule and their actual geographic location in real time. Moreover, because descriptive geographic information is provided, a quick review of the calendar information can provide useful information on the workers geographic location, such as their presence in a particular building. Moreover, to the extent location records define the geographic boundaries of major roadways and freeways, a manager could review a field workers real time calendar, which could display that the worker is presently driving on a roadway. The activity algorithm can specify the rate the worker is traveling, i.e., indicating stuck in traffic, etc.

In the described implementations, scheduled events and location/activity information were displayed together in a user calendar view. Alternatively, the calendar view may selectively display only scheduled events or location/activity information.

The described implementations presented the scheduled event and location/activity information at different times during a user specified time interval. However, the generated location/activity information may be presented in alternative formats. For instance, the user may generate a display of all locations visited and activities, and the time period during which the location was visited or activity performed would be displayed under the location/activity display.

FIGS. 3a, b, c, d illustrate one implementation of the data structures used to maintain the information used in the described implementations. However, those skilled in the art will recognize that the there are numerous ways the data shown in FIGS. 3a, b, c, d may be organized in data structures and a database for storage and retrieval.

In the described implementations, the PIM server 24 transmitted the PIM information to the client PIM 20 or some other client to display in a browser, such as a WML or HTML browser. In alternative implementations, the PIM server 24 may provide the generated PIM information in alternative presentation and file formats, or alternative text markup languages than those described herein. Moreover, the location information presented to the user through the browser may present information in alternative presentation formats, such as audio, movies, etc. For instance, the calendar may display a hypertext description of the visited location. User selection of the hypertext description could present a movie or audio file about the visited location.

Still further, the user, through the wireless device 2 or some other computer may provide images or audio files taken from a location to associate with measured position records. In certain implementations, the wireless device 2 could include a microphone, still image camera, video camera etc. The user could then associate such multi-media files image information with the location that the PIM client 20 would provide with the measured position records 54 sent to the PIM server 24. This information would be made available to those viewing the calendar providing the location/activity information.

In the described implementation, the generated location was expressed as an x, y, z position coordinate. However, as discussed, the position coordinate may be expressed as any set of numbers used in specifying a location in space, or may comprise a code or descriptor defining a location in space.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for providing information on a scheduled event to attendees of the event, comprising:
transmitting electronic information on a scheduled event occurring at an event time and at an event location;
receiving a response from an attendee indicating acceptance of the scheduled event;
providing a scheduled event record to include in a calendar database having calendar records, wherein calendar information for the attendee is generated from the calendar records for the attendee; and
receiving a personal profile record for the attendee maintained in the calendar records of the attendee in the calendar database, wherein the personal profile record includes personal preference information of the attendee.

2. The method of claim 1, further comprising:
adding information on the attendee and the personal preference information to a record for the attendee in an attendee database; and
processing the attendee database to access personal preference information on attendees.

3. The method of claim 1, further comprising:
processing the personal profile records of attendees of the scheduled event in order to accommodate attendee preferences at the event.

4. The method of claim 1, wherein the personal preference information indicates at least one of medical conditions, group affiliations, food preferences, and contact information.

5. The method of claim 1, wherein the personal profile records indicate an address of a wireless device of the attendee, further comprising:
generating information on the scheduled event; and
transmitting the generated information to the addresses of the attendee wireless devices indicated in the personal profile records of the attendee.

6. The method of claim 5, wherein the generated information indicates a change in a time for the scheduled event.

7. The method of claim 5, wherein the generated information is transmitted while the scheduled event is in progress.

8. The method of claim 1, wherein the transmitted electronic information comprises an electronic message transmitted to an attendee device to display information on the scheduled event at the attendee device.

9. The method of claim 1, wherein the provided scheduled event record comprises adding a shadowed scheduled event record to the calendar records of the attendee, wherein information on the shadowed scheduled event is displayed in the calendar information of the attendee as a non-committed event.

10. The method of claim 1, wherein the transmitted electronic information includes code to enable the attendee to transmit the response indicating acceptance of the scheduled event.

11. The method of claim 10, wherein the code comprises a hypertext link causing transmission of the response.

12. The method of claim 1, wherein attendee records are maintained for multiple attendees.

13. A method for accepting a scheduled event, comprising:
receiving electronic information on a scheduled event occurring at an event time and at an event location;
transmitting a response indicating acceptance of the scheduled event;
receiving a scheduled event record to include in a calendar database having calendar records for the attendee, wherein calendar information for an attendee accepting the scheduled event is generated from the calendar records; and
transmitting a personal profile record for the attendee maintained in the calendar records for the attendee in the calendar database having personal preference information of the attendee.

14. The method of claim 13, wherein the personal preference information indicates at least one of medical conditions, group affiliations, food preferences, and contact information.

15. The method of claim 13, wherein the received electronic information on the scheduled event comprises a shadowed scheduled event record, further comprising:
displaying information on the shadowed scheduled event in the calendar information of the attendee as a non-committed event.

16. A method for tracking attendees of a scheduled event, wherein the scheduled event occurs during an event time period at an event location, comprising:
providing position records in a database for the attendees, wherein each position record includes a time period value and position coordinates generated by a wireless device associated with the attendee that indicates a location of the wireless device for time periods; and
processing the position records for each attendee to determine information to transmit to the attendee.

17. The method of claim 16, wherein processing the position records for each attendee further comprises:
determining, before the event time period, whether current position records for a predetermined number of attendees have position coordinates outside of the event location to determine whether to delay the scheduled event.

18. The method of claim 16, wherein the network address comprises the network address of the attendee wireless device.

19. The method of claim 16, wherein processing the position records for each attendee further comprises:
determining whether there is at least one position record including a time period value within the event time period and position coordinates within the event location; and
transmitting an electronic survey to a network address of the attendee requesting information on the scheduled event if the attendee position records indicate that the attendee was located at the event location during the event time period.

20. The method of claim 19, wherein transmitting the electronic survey to the attendee network address further comprises:
transmitting a first electronic survey to the network address including inquiries on why the attendee did not attend the scheduled event if there is no position record for the attendee including a time period value within the event time period and position coordinates within the event location; and
transmitting a second electronic survey to the network address including inquiries as to the attendee's opinion of the scheduled event if there is at least one position record for the attendee including a time period value within the event time period and position coordinates within the event location.

21. The method of claim 20, wherein transmitting the electronic survey further comprises:
transmitting a first electronic survey to the attendee network address including inquiries on why the attendee did not attend the scheduled event if there is no position record for the attendee including a time period value within the event time period and position coordinates within the event location;
transmitting a second electronic survey to the attendee network address including inquiries on why the attendee left the scheduled event early if the position records including time period values within the event time period do not include position coordinates within the event location that indicate that the attendee was within the event location less than a minimum time; and
transmitting a third electronic survey to the attendee network address including inquiries on why the attendee left the scheduled event early if the position records including time period values within the event time period include position coordinates within the event location that indicate that the attendee was within the event location greater than the minimum time.

22. The method of claim 16, far performing for each attendee:
setting a trigger on each attendee having one position record including one time period value within the event time period and one position coordinate within the event location, wherein the trigger is activated if a most recent position record includes position coordinates outside of the event location, wherein the electronic survey is transmitted if the trigger is activated.

23. The method of claim 22, wherein the electronic survey includes inquiries on why the attendee left the event.

24. The method of claim 22, wherein the trigger is set when the scheduled event begins.

25. A system for providing information on a scheduled event to attendees of the event, comprising:
a storage device;
a calendar database included in the storage device;
means for transmitting electronic information on a scheduled event occurring at an event time and at an event location;
means for receiving a response from an attendee indicating acceptance of the scheduled event;
means for providing a scheduled event record to include in a calendar database having calendar records, wherein calendar information for the attendee is generated from the calendar records for the attendee; and
means for receiving a personal profile record for the attendee maintained in the calendar records of the attendee in the calendar database, wherein the personal profile record includes personal preference information of the attendee.

26. The system of claim 25, further comprising:
means for adding information on the attendee and the personal preference information to a record for the attendee in an attendee database; and
means for processing the attendee database to access personal preference information on attendees.

27. The system of claim 25, further comprising:
means for processing the personal profile records of attendees of the scheduled event in order to accommodate attendee preferences at the event.

28. The system of claim 25, wherein the personal preference information indicates at least one of medical conditions, group affiliations, food preferences, and contact information.

29. The system of claim 25, wherein the personal profile records indicate an address of a wireless device of the attendee, further comprising:
means for generating information on the scheduled event; and
means for transmitting the generated information to the addresses of the attendee wireless devices indicated in the personal profile records of the attendee.

30. The system of claim 29, wherein the generated information indicates a change in a time for the scheduled event.

31. The system of claim 29, wherein the generated information is transmitted while the scheduled event is in progress.

32. The system of claim 25, wherein the transmitted electronic information comprises an electronic message transmitted to an attendee device to display information on the scheduled event at the attendee device.

33. The system of claim 25, wherein the means for providing the scheduled event record comprises providing a shadowed scheduled event record to the calendar records of the attendee, wherein information on the shadowed scheduled event is displayed in the calendar information of the attendee as a non-committed event.

34. The system of claim 25, wherein the transmitted electronic information includes code to enable the attendee to transmit the response indicating acceptance of the scheduled event.

35. The system of claim 34, wherein the code comprises a hypertext link causing transmission of the response.

36. The system of claim 25, wherein attendee records are maintained for multiple attendees.

37. A system for accepting a scheduled event in a calendar database having calendar records for attendees, wherein calendar information for attendees is generated from the calendar records, further comprising:
means for receiving electronic information on a scheduled event occurring at an event time and at an event location;
means for transmitting a response indicating acceptance of the scheduled event;
means for receiving a scheduled event record to include in the calendar database having calendar records for the attendee, and
means for transmitting a personal profile record for the attendee maintained in the calendar records for the attendee in the calendar database having personal preference information of the attendee.

38. The system of claim 37, wherein the personal preference information indicates at least one of medical conditions, group affiliations, food preferences, and contact information.

39. The system of claim 37, wherein the received electronic information on the scheduled event comprises a shadowed scheduled event record, further comprising:
means for displaying information on the shadowed scheduled event in the calendar information of the attendee as a non-committed event.

40. A system for tracking attendees of a scheduled event, wherein the scheduled event occurs during an event time period at an event location, comprising:
a database including position records for the attendees, wherein each position record includes a time period value and position coordinates generated by a wireless device associated with the attendee that indicates a location of the wireless device for time periods; and
means for processing the position records in the data base for each attendee to determine information to transmit to the attendee.

41. The system of claim 40, wherein the means for processing the position records for each attendee further performs:
determining, before the event time period, whether current position records for a predetermined number of attendees have position coordinates outside of the event location to determine whether to delay the scheduled event.

42. The system of claim 40, wherein the network address comprises the network address of the attendee wireless device.

43. The system of claim 40, wherein the means for processing the position records for each attendee further performs:
determining whether there is at least one position record including a time period value within the event time period and position coordinates within the event location; and
transmitting an electronic survey to a network address of the attendee requesting information on the scheduled event if the attendee position records indicate that the attendee was located at the event location during the event time period.

44. The system of claim 43, wherein the means for transmitting the electronic survey to the attendee network address further performs:
transmitting a first electronic survey to the network address including inquiries on why the attendee did not attend the scheduled event if there is no position record for the attendee including a time period value within the event time period and position coordinates within the event location; and
transmitting a second electronic survey to the network address including inquiries as to the attendee's opinion of the scheduled event if there is at least one position record for the attendee including a time period value within the event time period and position coordinates within the event location.

45. The system of claim 43, wherein the means for transmitting the electronic survey further performs:
transmitting a first electronic survey to the attendee network address including inquiries on why the attendee did not attend the scheduled event if there is no position record for the attendee including a time period value within the event time period and position coordinates within the event location;
transmitting a second electronic survey to the attendee network address including inquiries on why the attendee left the scheduled event early if the position records including time period values within the event time period do not include position coordinates within the event location that indicate that the attendee was within the event location less than a minimum time; and
transmitting a third electronic survey to the attendee network address including inquiries on why the attendee left the scheduled event early if the position records including time period values within the event time period include position coordinates within the event location that indicate that the attendee was within the event location greater than the minimum time.

46. The system of claim 43, further comprising:
means for setting a trigger on each attendee having one position record including one time period value within the event time period and one position coordinate within the event location, wherein the trigger is activated if a most recent position record includes position coordinates outside of the event location, wherein the electronic survey is transmitted if the trigger is activated.

47. The system of claim 46, wherein the electronic survey includes inquiries on why the attendee left the event.

48. The system of claim 46, wherein the trigger is wet when the scheduled event begins.

49. An article of manufacture including code for providing information on a scheduled event to attendees of the event by:
transmitting electronic information on a scheduled event occurring at an event time and at an event location;
receiving a response from an attendee indicating acceptance of the scheduled event;
providing a scheduled event record to include in a calendar database having calendar records, wherein calendar information for the attendee is generated from the calendar records for the attendee; and
receiving a personal profile record for the attendee maintained in the calendar records of the attendee in the calendar database, wherein the personal profile record includes personal preference information of the attendee.

50. The article of manufacture of claim 49, further comprising:
adding information on the attendee and the personal preference information to a record for the attendee in an attendee database; and
processing the attendee database to access personal preference information on attendees.

51. The article of manufacture of claim 49, further comprising:
processing the personal profile records of attendees of the scheduled event in order to accommodate attendee preferences at the event.

52. The article of manufacture of claim 49, wherein the personal preference information indicates at least one of medical conditions, group affiliations, food preferences, and contact information.

53. The article of manufacture of claim 49, wherein the personal profile records indicate an address of a wireless device of the attendee, further comprising:
generating information on the scheduled event; and
transmitting the generated information to the addresses of the attendee wireless devices indicated in the personal profile records of the attendee.

54. The article of manufacture of claim 53, wherein the generated information indicates a change in a time for the scheduled event.

55. The article of manufacture of claim 53, wherein the generated information is transmitted while the scheduled event is in progress.

56. The article of manufacture of claim 49, wherein the transmitted electronic information comprises an electronic message transmitted to an attendee device to display information on the scheduled event at the attendee device.

57. The article of manufacture of claim 49, wherein the provided scheduled event record comprises adding a shadowed scheduled event record to the calendar records of the attendee, wherein information on the shadowed scheduled event is displayed in the calendar information of the attendee as a non-committed event.

58. The article of manufacture of claim 49, wherein the transmitted electronic information includes code to enable the attendee to transmit the response indicating acceptance of the scheduled event.

59. The article of manufacture of claim 49, wherein the code comprises a hypertext link causing transmission of the response.

60. The article of manufacture of claim 49, wherein attendee records are maintained for multiple attendees.

61. An article of manufacture including code for accepting a scheduled event by:
receiving electronic information on a scheduled event occurring at an event time and at an event location;
transmitting a response indicating acceptance of the scheduled event;
receiving a scheduled event record to include in a calendar database having calendar records for the attendee, wherein calendar information for an attendee accepting the scheduled event is generated from the calendar records; and
transmitting a personal profile record for the attendee maintained in the calendar records for the attendee in the calendar database having personal preference information of the attendee.

62. The article of manufacture of claim 61, wherein the personal preference information indicates at least one of medical conditions, group affiliations, food preferences, and contact information.

63. The article of manufacture of claim 61, wherein the received electronic information on the scheduled event comprises a shadowed scheduled event record, further comprising:
means for displaying information on the shadowed scheduled event in the calendar information of the attendee as a non-committed event.

64. An article of manufacture including code for tracking attendees of a scheduled event, wherein the scheduled event occurs during an event time period at an event location by:
providing position records in a database for the attendees, wherein each position record includes a time period value and position coordinates generated by a wireless device associated with the attendee that indicates a location of the wireless device for time periods; and
processing the position records for each attendee to determine information to transmit to the attendee.

65. The article of manufacture of claim 64, wherein processing the position records for each attendee further comprises:
determining, before the event time period, whether current position records for a predetermined number of attendees have position coordinates outside of the event location to determine whether to delay the scheduled event.

66. The article of manufacture of claim 64, wherein the network address comprises the network address of the attendee wireless device.

67. The article of manufacture of claim 64, wherein processing the position records for each attendee further comprises:
determining whether there is at least one position record including a time period value within the event time period and position coordinates within the event location; and
transmitting an electronic survey to a network address of the attendee requesting information on the scheduled event if the attendee position records indicate that the attendee was located at the event location during the event time period.

68. The article of manufacture of claim 67, wherein transmitting the electronic survey to the attendee network address further comprises:
transmitting a first electronic survey to the network address including inquiries on why the attendee did not attend the scheduled event if there is no position record for the attendee including a time period value within the event time period and position coordinates within the event location; and
transmitting a second electronic survey to the network address including inquiries as to the attendee's opinion of the scheduled event if there is at least one position record for the attendee including a time period value within the event time period and position coordinates within the event location.

69. The article of manufacture of claim 68, wherein transmitting the electronic survey further comprises:
transmitting a first electronic survey to the attendee network address including inquiries on why the attendee did not attend the scheduled event if there is no position record for the attendee including a time period value within the event time period and position coordinates within the event location;
transmitting a second electronic survey to the attendee network address including inquiries on why the attendee left the scheduled event early if the position records including time period values within the event time period do not include position coordinates within the event location that indicate that the attendee was within the event location less than a minimum time; and
transmitting a third electronic survey to the attendee network address including inquiries on why the attendee left the scheduled event early if the position records including time period values within the event time period include position coordinates within the event location that indicate that the attendee was within the event location greater than the minimum time.

70. The article of manufacture of claim 64, further performing for each attendee:
setting a trigger on each attendee having one position record including one time period value within the event time period and one position coordinate within the event location, wherein the trigger is activated if a most recent position record includes position coordinates outside of the event location, wherein the electronic survey is transmitted if the trigger is activated.

71. The article of manufacture of claim 70, wherein the electronic survey includes inquiries on why the attendee left the event.

72. The article of manufacture of claim 70, wherein the trigger is set when the scheduled event begins.
